(19) United States
(12) Patent Application Publication
(10) Pub. No.: US 2026/0106246 A1
(43) Pub. Date: Apr. 16, 2026

(54) BATTERY TRAY AND METHOD OF MANUFACTURING A BATTERY TRAY

(71) Applicants: voestalpine Stahl GmbH, Linz (AT); voestalpine Metal Forming GmbH, Krems an der Donau (AT)

(72) Inventors: Karl RADLMAYR, Linz (AT); Richard GEIRHOFER, Wilhering (AT); Johannes SELL, Linz (AT)

(73) Assignees: voestalpine Stahl GmbH, Linz (AT); voestalpine Metal Forming GmbH, Krems an der Donau (AT)

(21) Appl. No.: 19/354,876

(22) Filed: Oct. 10, 2025

(30) Foreign Application Priority Data
Oct. 11, 2024 (DE) 10 2024 129 515.5

(51) Int. Cl. H01M 10/48; H01M 10/42; H01M 50/227; H01M 50/229; H01M 50/231; H01M 50/233; H01M 50/249

(52) U.S. Cl. CPC H01M 10/48; H01M 10/4257; H01M 50/227; H01M 50/229; H01M 50/231; H01M 50/233; H01M 50/249

(57) ABSTRACT

The invention provides a battery tray for holding a battery, in particular a vehicle battery, and a method for manufacturing a battery tray. The battery tray comprises at least:
a tray housing;
wherein a layer of electrically conductive tracks is arranged on or above a continuous first layer of the tray housing made of a composite material on the concave side thereof, and
wherein a plurality of electrically readable deformation measuring structures is formed in the layer of electrically conductive tracks at least on a flat section of the tray housing.

### RELATED APPLICATION(S)

This application claims the benefit of priority of German Patent Application No. 10 2024 129 515.5 filed on Oct. 11, 2024. The contents of the above application are all incorporated by reference as if fully set forth herein in their entirety.

### FIELD AND BACKGROUND OF THE INVENTION

The present invention relates to a battery tray and a method for manufacturing a battery tray, in particular a battery tray for accommodating a vehicle battery in a vehicle.

Rechargeable batteries, such as vehicle batteries for battery electric or hybrid vehicles, are often stored in battery trays in which they can be transported and protected from external influences.

Vehicle batteries in particular are typically positioned as low as possible in the vehicle in order to keep the center of gravity low and thus improve the vehicle's road holding. The respective battery tray in which the vehicle battery is arranged is usually made of a robust material and helps, for example, to soften or completely ward off external impacts that could otherwise damage or even destroy the vehicle battery.

As damage to the vehicle battery can have a negative impact on other components or on the driving characteristics of the vehicle, it is advantageous to be able to recognize whether and to what extent the battery tray has been damaged.

DE 10 2020 119 287 A1, for example, describes a protective plate with an integrated conductor track as a deformation sensor, which is arranged on the convex outer side of a battery tray. The protective plate can thus keep various external influences away from the battery tray to a certain extent. If the protective plate fulfills this function, it will therefore often happen that the integrated deformation sensor reports damage because the protective plate has been damaged, whereby it then remains unclear whether the battery tray to be protected (or even the vehicle battery itself) has actually been damaged.

### SUMMARY OF THE INVENTION

It is therefore a task of the present invention to provide an improved battery tray and a method for manufacturing an improved battery tray, which in particular enable improved detection of any damage.

These tasks are solved by the subject matter of the independent claims and the described aspects of the present invention.

Accordingly, according to a first aspect, a battery tray for holding a battery (in particular a vehicle battery) is provided, comprising:
a tray housing;
wherein a layer of electrically conductive tracks is

arranged on (i.e. directly on) or above (i.e. for example also indirectly on) a continuous first layer of the tray housing made of a composite material on its concave side, and
wherein a plurality of electrically readable deformation measuring structures are formed in the layer of electrically conductive tracks at least on a flat section of the tray housing.

It is therefore an underlying idea of the present invention that deformation measuring structures are arranged on the inside of a battery tray housing, i.e. on the concave side. In this way, there is an increased probability that deformations detected by these deformation measuring structures not only affect an upstream protective plate or the tray housing itself, but have actually damaged the internal battery. In the assembled state, the layer of electrically conductive tracks with the deformation measuring structures is therefore located in particular between the battery (e.g. a vehicle battery) and the tray housing.

The layer of electrically conductive tracks can either be arranged directly on the continuous first layer, or above it, i.e. further layers can be present in between, for example at least one electrically insulating layer and/or a lacquer layer or the like.

According to some preferred embodiments, variants or refinements of embodiments, the layer of electrically conductive tracks is embedded in an (in particular otherwise continuous) second layer of the tray housing, for example laterally or on all sides, thus in particular also from above, i.e. on a side of the layer of electrically conductive tracks facing away from the continuous first layer. The continuous second layer can be an insulating layer and/or a protective layer.

According to some preferred embodiments, variants or refinements of embodiments, the second layer is a lacquer coating which can be applied in particular over the layer of electrical conductive tracks and gaps in this layer. This lacquer coating as second layer may be applied directly on the layer of electrically conductive tracks, where present, and otherwise directly on the layer to which the layer of electrically conductive tracks is attached.

According to some preferred embodiments, variants or refinements of embodiments, the tray housing is formed from a fiber composite material, in particular comprising glass fiber and/or carbon fiber inserts, hardened in a corresponding shape. The tray housing can thus be formed, for example, from carbon fiber reinforced plastic, CFRP. Such tray housings provide a particularly good balance between low weight and robustness.

According to some preferred embodiments, variants or refinements of embodiments, the tray housing comprises a first component made of a composite material formed in a tray shape and a flat (i.e. planar) metallic second component, for example a metallic plate. The metallic second component may, in particular, be attached directly to a tray bottom of the tray shape of the first component on its concave side. The continuous first layer of the tray housing can be formed by the first component.

In this way, the advantages of metallic materials and composite materials can be combined: the composite material is robust and light, but can sometimes act elastically, so that damage to the composite material is sometimes not visible. In particular, in unfavorable cases, the composite material could be deformed and then elastically return to its original shape between two measurements of the deformation state, especially if it is planned that measurements of the deformation state be taken regularly. The deformation that has occurred, which could have caused damage to the internal battery, would thus be potentially invisible to the measurements.

The metallic material, in contrast, usually retains its shape after damage, so that damage remains physically visible and, more importantly, can still be detected by subsequent measurements. Furthermore, the layer of electrically conductive tracks can be easily attached to the metallic second component, and this in turn can be easily attached to the composite material.

The second component is advantageously designed as a metallic plate with a thickness of 1 millimeter or less, in particular 0.5 millimeters or less. In this way, the overall weight of the tray housing is increased only slightly.

The second component can, for example, be designed as so-called “tailor-made functional steel”, TFS, and thus be produced in corresponding advanced manufacturing processes.

The first component can be formed by a fiber composite hardened in a corresponding shape, in particular comprising glass fiber and/or carbon fiber inserts. The tray housing can thus be formed, for example, from carbon fiber reinforced plastic, CFRP.

Another advantage of the variant with the two different components is that the battery tray can be easily adapted to customer requirements. For example, the first component, i.e. the tray shape made of composite material, can be manufactured with the same shape for a large number of products, which also offers advantages in terms of storage and warehouse logistics. Different interconnections or cable arrangements of the battery tray can then be provided in a simple manner by selecting and attaching a different second metallic component in each case.

For example, different functions can also be provided in the same geometric tray shape, depending on the metallic plate arranged in it, for example for different battery types, vehicle types or for basic and premium functions. The geometric shape of the battery tray can thus be optimally adapted to a specific vehicle type, a body, a vehicle platform, etc., while the electrical functions, but also, for example, the location of the connection contacts, can be individually adapted to the battery tray.

In addition, it is easy to change the cable arrangement of an existing battery tray by simply replacing the metallic second component, i.e. the metallic plate. An upgrade or recycling is therefore possible without any problems.

According to some preferred embodiments, variants or refinements of embodiments, the deformation measuring structures are formed at least partially (or all) as capacitive sensor structures, for example at least partially (or all) as interdigital electrodes. A deformation of the tray housing changes the capacitive couplings between the individual electrodes of the interdigital electrodes of affected sensor structures, which can be detected by a corresponding evaluation device.

According to some preferred embodiments, variants or refinements of embodiments, the deformation measuring structures are at least partially designed as resistive sensor structures. As a result of a deformation of the tray housing, affected deformation measuring structures are stretched, compressed or interrupted, which changes their electrical resistance (in particular ohmic resistance), which can be detected by a corresponding evaluation device.

Temperature compensation can be provided, according to which a temperature of the battery tray, the tray housing or even individual deformation measuring structures is recorded and thermally induced changes in the electrical resistance of the deformation measuring structures are disregarded during evaluation by the evaluation device. For this purpose, one or more temperature sensors can be arranged in or on the tray housing, which can also be evaluated by the evaluation device.

According to some preferred embodiments, variants or refinements of embodiments, the (in particular capacitive or resistive) sensor structures are covered with a plastic foam, in particular polyurethane foam or polystyrene, on a side facing away from the tray housing. The plastic foam can be arranged directly on the sensor structures and/or the second layer of the tray housing, or with an intermediate space.

According to some preferred embodiments, variants or refinements of embodiments, the battery tray further comprises an evaluation device which is adapted to:
apply an electrical excitation signal to at least some (and preferably all) of the deformation measuring structures,
as well as read out a respective signal response of the deformation measuring structures to the respective excitation signal in order to determine, based on this, a normal state or a deformation state of the respective deformation measuring structure.

The nature of the excitation signal and signal response depend in particular on the selected design of the deformation measuring structures: in the case of resistive sensor structures as deformation measuring structures, the excitation signal can, for example, be an applied voltage with a predetermined voltage value, and the signal response correspondingly a measured electrical current, which thus indicates the current electrical resistance. In the case of capacitive sensor structures, the excitation signal can be an alternating current signal, for example, and the signal response can be a reactive current dependent on the current capacitance.

The evaluation device can have a digital computing device. Such a digital computing device can be or be realized as any device which is capable of computing, and in particular of executing software, an app or an algorithm. For example, the computing device may comprise at least one processing unit, e.g. a central processing unit (CPU) and/or a graphics processing unit (GPU) and/or a field programmable logic array (FPGA) and/or an application specific integrated circuit (ASIC) and/or a combination thereof. The computing device may further comprise a working memory operatively coupled to the at least one processor unit, and a non-volatile memory operatively coupled to the at least one processor unit and the working memory. The computing device may be implemented fully or entirely in a local device and/or fully or entirely in a remote system such as a remotely located server and/or a cloud computing platform.

The evaluation device can also be arranged in the concave cavity of the battery tray, for example attached directly or indirectly to the bottom of the battery tray, in particular connected to conductive tracks of the layer of electrically conductive tracks. This means that signal lines for the excitation signals and the signal responses can be advantageously arranged within the layer of electrically conductive tracks.

The evaluation device can also be arranged outside the battery tray. Electrical inlet and outlet conduits between the deformation measuring structures and the evaluation device can run along the inner walls of the battery tray housing.

According to some preferred embodiments, variants or refinements of embodiments, the evaluation device can be calibrated in a calibration process in such a way that a respective current signal response during the calibration process indicates the normal state and deviations therefrom indicate the deformation state of the respective deformation measuring structure. This means that the calibration process can not only be carried out as an initial calibration immediately after completion of the battery tray or after its installation (e.g. in a vehicle), but regular or event-based calibration processes are also possible as recalibrations. A possible recalibration concerns, for example, a current temperature in the battery tray and can be carried out regularly or event-based (e.g. when temperature thresholds are exceeded and/or not reached).

A recalibration can also be carried out after a deformation condition has been detected, for example if a deformation of the battery tray has been detected that does not impair the function of the battery tray (or only within a predetermined tolerance range). The current state can then be redefined as the normal state in the calibration process so that only additional deformations beyond this are detected.

According to a further aspect, the invention also provides a method of manufacturing a battery tray, comprising at least the steps:
manufacturing a tray shape made of a composite material; and
applying a plurality of electrically readable deformation measuring structures to or over the tray shape, especially by means of a spray printing process.

According to yet another aspect, the invention also provides a further method of manufacturing a battery tray, comprising at least the steps of:
applying a plurality of electrically-readable deformation measuring structures to (i.e. directly on) or over (i.e. for example, also indirectly on) a metallic plate; and
fixing the metallic plate internally to a tray bottom of a tray-shaped composite material.

Optionally, the method also includes manufacturing the composite material in the form of a tray.

The forming of the tray structure is thus completely decoupled from the application of the deformation measuring structures to their carrier. This means that the most suitable methods can be used for applying the deformation measuring structures and for manufacturing the tray shape, without taking into account the other component.

The separate production of the components also makes it possible to combine one and the same tray form with differently designed metallic plates (in particular with regard to the deformation measuring structures and/or their wiring). Thus, for battery trays with different electrical variants, only the production of the component with the metallic plate needs to be changed, which results in positive economies of scale. In addition, the metallic plates, even with the deformation measuring structures attached to them, can be stored more easily than the finished battery trays, which also simplifies the logistics of production. In all variants and aspects, the tray shape can be made from the composite material by hardening (in a tray shape) a fiber composite material, in particular comprising glass fiber and/or carbon fiber inserts.

The tray housing can thus, for example, be made of carbon fiber reinforced plastic, CFRP.

According to some preferred embodiments, variants or refinements of embodiments, the method further comprises the following steps:
applying an electrical excitation signal to at least part of the deformation measuring structures;
electrical reading out a respective signal response of the deformation measuring structures to the respective applied excitation signal; and
calibrating an evaluation device in such a way that the signal response readout in each case indicates an undeformed normal state of the respective deformation measuring structure and deviations in the signal response indicate a deformation state of the respective deformation measuring structure.

As already described above with reference to the evaluation device, the battery tray can be optimally adjusted in this way, in particular immediately after the battery tray has been manufactured and/or after the battery tray has been installed in its intended destination, such as a vehicle.

Applying the excitation signal, reading out the signal response and/or calibrating the evaluation device (in particular all three of these steps) can advantageously be carried out once or several times, regularly or event-based, during operation of the battery in the battery tray, in particular for recalibration.

Further advantageous embodiments, variants and refinements of embodiments are shown in the following detailed description with reference to the figures.

### BRIEF DESCRIPTION OF THE SEVERAL VIEWS OF THE DRAWING(S)

The invention is explained in more detail below with reference to examples of embodiments in the figures of the drawings.

FIG. 1 shows a schematic cross-sectional view illustrating a battery tray according to one embodiment of the present invention;

FIG. 2A shows a schematic isometric representation of the battery tray from FIG. 1;

FIG. 2B shows a schematic top view of a battery tray according to one variant;

FIG. 3 shows an exemplary section of a battery tray according to a variant of the invention;

FIG. 4 shows an exemplary section of a battery tray according to the invention in accordance with a further variant;

FIG. 5 shows a schematic cross-sectional view illustrating a battery tray according to a further embodiment of the present invention;

FIG. 6 shows a schematic flowchart illustrating a method of manufacturing a battery tray according to one embodiment of the present invention; and

FIG. 7 shows a schematic flowchart explaining a method of manufacturing a battery tray according to another embodiment of the present invention.

In all figures, identical or functionally identical elements and devices have been given the same reference signs, unless otherwise indicated. The designation and numbering of the process steps does not necessarily imply a sequence, but serves the purpose of better differentiation, although in some variants the sequence can also correspond to the sequence of the numbering.

### DESCRIPTION OF SPECIFIC EMBODIMENTS OF THE INVENTION

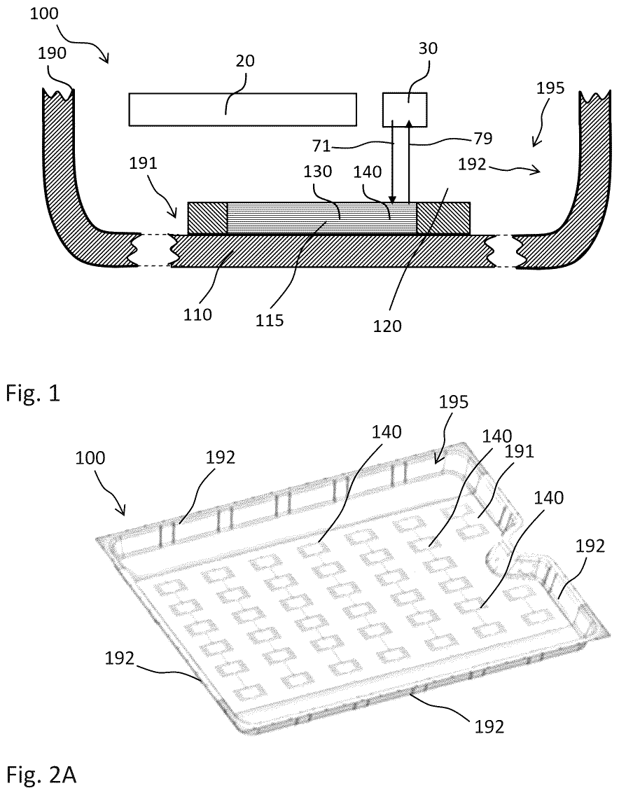

FIG. 1 shows a schematic cross-sectional representation for explaining a battery tray 100 according to an embodiment of the present invention.

The battery tray 100 of FIG. 1 comprises a tray housing 190, which is formed in the shape of a tray (with a tray bottom 191 and tray walls 192) made of a composite material. The composite material can be formed by a fiber composite material hardened in a corresponding shape, in particular comprising glass, fiber and/or carbon fiber inserts. The tray housing 190 can thus be formed, for example, from carbon fiber reinforced plastic, CFRP. The composite material forms a first continuous layer 110 of the tray housing 190.

Here and in the following, terms such as “inside” or “inner side” always refer to the concave cavity 195 formed by the tray shape, while “outside” or “outer side” always refer to the space outside the tray shape, in particular on its convex side.

The battery tray 100 is provided to receive a battery 20 in the concave cavity 195. In some variants, the battery tray 100 comprises a battery 20 arranged in the concave cavity 195, in particular a vehicle battery.

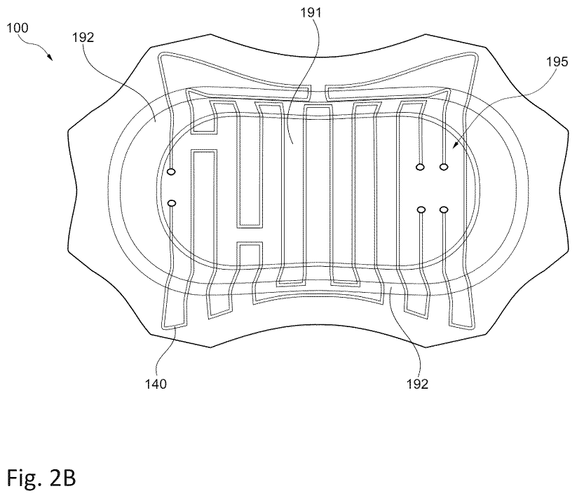

A layer of electrically conductive tracks 130 is arranged above the inside of the first layer 110, here for example directly on it. A plurality of electrically readable deformation measuring structures 140 are formed in the layer of electrically conductive tracks 130 on a flat section of the tray housing 190 at the tray bottom 191, which are explained in more detail below with reference to FIGS. 2A to 4.

The layer of electrically conductive tracks 130 is optionally embedded in a continuous second layer 120, which can, for example, be designed as an electrically insulating lacquer coating. The second layer 120 can run both next to the layer of electrically conductive tracks 130 and above it in order to protect it inwardly against damage. For this purpose, the second layer 120 can be applied, for example, after the deformation measuring structures 140 have been applied over the first layer 110.

The battery tray 100 optionally also comprises an evaluation device 30, which is set up to apply an electrical excitation signal 71 to at least some (preferably all) of the deformation measuring structures 140, and to read out a respective (in particular electrical) signal response 79 of the deformation measuring structures 140 to the respective excitation signal 71, in order to determine, based thereon, a normal state or a deformation state of the respective deformation measuring structure 140.

The determination of a deformation state may either merely comprise the information that a deformation of the corresponding deformation measuring structure 140 has occurred, or may additionally comprise further information, for example a degree of deformation, a time of deformation and/or the like. The respective information can be indicated by an output signal of the evaluation device 30.

As shown schematically in FIG. 1, the evaluation device 30 can be inserted together with the battery 20 into the concave cavity 195 in the tray housing 190. For this purpose, the battery 20, the evaluation device 30 and the tray housing 190 can be dimensioned such that the evaluation device 30 and the battery 20 are mounted next to each other above or on the uppermost layer of the tray bottom 191 (here: on the layer of electrically conductive tracks 130 and the second layer 120).

The evaluation device 30 can be connected directly or indirectly to the conductive paths of the layer of electrically conductive paths 130 in order to be able to apply the excitation signals 71 to the deformation measuring structures 140 and to be able to receive the signal responses 79 from the deformation measuring structures 140. Wires, cables, flexible conductors or the like can be used for this purpose.

Alternatively, the evaluation device 30 can also be arranged outside the tray housing 190. In this case, inlet and outlet conduits or signal lines can be arranged between the deformation measuring structures 140 and the evaluation device 30 on the tray walls 191. For this purpose, the layer of electrically conductive tracks 130 can also extend completely or partially over the tray walls 191 and include the inlet and outlet conduits.

For the manufacturing, the layer of electrically conductive tracks 130 can be applied, for example, by means of a spray printing process to the composite material of the first layer 110 of the tray shape.

If the evaluation device 30 is arranged within the tray housing 190, inlet and outlet conduits from the evaluation device 30 to an external device can be provided, such as a vehicle computer and/or a battery control unit. Signals indicating the state of the deformation measuring structures 140 (normal state or deformation state in each case) determined by the evaluation device 30 can be output by the evaluation device 30 via an outlet conduit. For example, a trigger can be received via an inlet conduit, in response to which the evaluation device 30 transmits one or more excitation signals 71 and/or performs a calibration process.

FIG. 2A shows an exemplary isometric representation of a battery tray 100 according to the invention. Essentially the entire flat tray bottom 191 is provided with individual deformation measuring structures 140, preferably in a regular grid. The deformation measuring structures 140 can each be electrically readable individually, or can be fully or partially connected in series or in parallel in order to be read out at least partially as a group by the evaluation device 30.

The individual deformation measuring structures 140 can be capacitive or resistive, whereby either all deformation measuring structures 140 can be resistive, or all deformation measuring structures 140 can be capacitive, or some deformation measuring structures 140 can be resistive and other deformation measuring structures 140 can be capacitive.

FIG. 2B shows a schematic top view of a battery tray 100 according to a variant. In the battery tray of FIG. 2B, individual deformation measuring structures 140 also extend over the tray walls 192; thus, a deformation of the tray walls 192 can also be detected. As an example, three individual resistive deformation measuring structures 140 are shown in FIG. 2B as separate circuits, each of which can be used to monitor a corresponding area of the battery tray 100 for deformations.

These individual resistive deformation measuring structures 140 can be of the same or different design and shape, symmetrical or asymmetrical, and of the same or different size. In this way, for example, individual areas of the battery tray 100, in which certain sections of the battery 20 or other elements arranged in the battery tray 100 are located, can be individually monitored.

Either a respective evaluation device 130 or a common evaluation device 130 can be electrically connected via the connection contacts of the respective deformation measuring structure 140, which are shown open in FIG. 2B, in order to exchange the excitation signal 71 and the signal response 79.

The process of manufacturing the tray shape of the battery tray 100 from FIG. 2B made of the composite material allows a great deal of freedom in its geometric design, while the application of the deformation measuring structures 140 can, for example, be adapted to their geometric shape using a spray printing process, in order to achieve an optimal result.

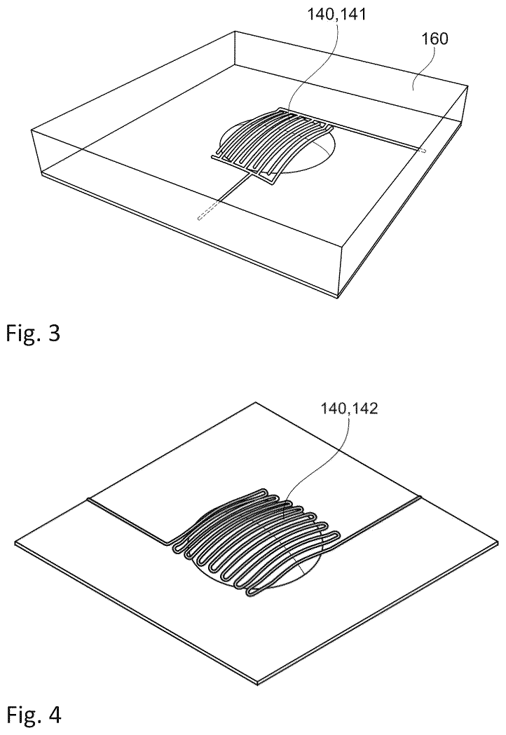

FIG. 3 shows an exemplary isometric representation of a section of the battery tray 100, which contains a single deformation measuring structure 140, which is realized as a capacitive sensor structure 141. The deformation measuring structure 140 shown comprises an interdigital electrode to which, for example, an alternating current signal can be applied as an excitation signal 71 by the evaluation device in order to determine the current capacity.

FIG. 3 shows an illustrative case in which the substrate on which the deformation measuring structure 140 is located has already been deformed from the outside (bottom in FIG. 3) in the shape of a spherical section. The current capacitance of the interdigital electrode thus differs from the capacitance that was determined during a calibration of this deformation measuring structure 140 (preferably in the undeformed state), so that, on this basis, the evaluation device 30 can determine a deformation state of this deformation measuring structure 140.

To improve the measurement, a plastic foam 160, for example polyurethane foam, polystyrene, or the like, can be applied to or over the layer of electrically conductive tracks 130. This acts not only as an additional protective layer (of the battery arranged at the top in FIG. 3 against external influences and of the layer of electrically conductive tracks 130 against internal influences), but also as an additional dielectric between the interdigital electrodes. When the tray housing 190 is deformed from the outside, this plastic 160 is thus also deformed (compressed or stretched), which additionally causes the electrical capacitance of the capacitive sensor structure 141 to change in a measurable way.

FIG. 4 shows an exemplary isometric representation of a section of the battery tray 100, which contains a single deformation measuring structure 140, which is realized as a resistive sensor structure 142.

As can be seen in FIG. 4, a single electrical line within the layer of electrically conductive tracks 130 can be folded forwards and backwards along itself several times to form the resistive sensor structure 142, in each case with an insulating distance between parallel line strands, so that a flat section densely covered by the electrical line is formed, here in a rectangular, in particular square, shape.

FIG. 4 also shows an example of an existing deformation of the substrate of the deformation measuring structure 140, as a result of which individual sections of the electrical line of the deformation measuring structure 140 are compressed or (above all) stretched. Short circuits or complete interruption due to severing may also occur. In each of these cases, the electrical resistance of the resistive sensor structure 142 changes, which in turn can be detected by the evaluation device 30.

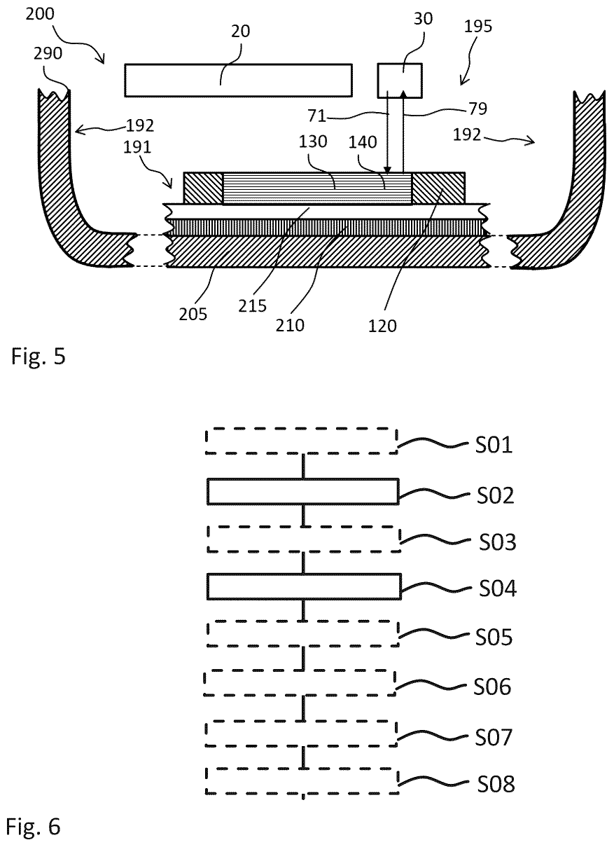

FIG. 5 shows a schematic cross-sectional representation for explaining a battery tray 200 according to a further embodiment of the present invention.

The battery tray 200 of FIG. 5 is a variant of the battery tray 100 of FIG. 1 and differs from the latter in that the tray housing 290 of the battery tray 200 comprises two components. A first component consists of, or comprises, a tray shape 205 made of a composite material, with a tray bottom 191.

A metallic plate 210 with an electrically insulating coating 215 is attached to or above the tray bottom 191 as a second component of the tray housing 290, on or above which the layer of electrically conductive tracks 130 and the second layer 120 are arranged. In the embodiment according to FIG. 5, the composite material 305 can thus be regarded as realizing a first layer.

In this variant, the flat metallic plate 210 with the deformation measuring structures 140 attached thereto can advantageously be inserted into the flat tray bottom 191 on the inside of the tray shape 205 made of the composite material after its manufacture and fixed there, for example glued. The metallic plate 210 may be formed with a thickness of 1 millimeter or less, in particular 0.5 millimeter or less, which makes it particularly light.

The structural stability of the tray housing 290 is thus essentially provided by the first component, i.e. the tray shape 205 made of a composite material, while the electrical functionality, in particular the deformation sensors, is provided by the metallic plate 210 with the deformation measuring structures 140 arranged thereon.

In the following, a method for manufacturing the battery trays 100; 200 according to the invention will be described. In order to explain its process steps, reference signs from the preceding FIGS. 1-5 will be used in some cases, it being understood that this is not intended to be restrictive. In order to avoid repetition, the properties of individual elements are not always described in detail; for this purpose, reference is made to the preceding abstract description of the invention and to the detailed description of FIGS. 1-5.

FIG. 6 shows a schematic flow chart explaining a method for manufacturing a battery tray. The battery tray produced may be the battery tray 200 described in the foregoing, a variant or refinement thereof, or a battery tray different therefrom. Accordingly, the method is adaptable according to all options, variants, embodiments and refinements described in relation to all battery trays according to the invention and in particular the battery tray 200 according to the invention, and vice versa.

In a step S02, a plurality of electrically readable deformation measuring structures 140 are applied to or over a metallic plate 210, for example as explained in the foregoing with reference to FIG. 5. Since the metallic plate 210 is flat, the conductive tracks of the layer of electrically conductive tracks 130 can be applied, for example, by means of a printing process. However, other methods are also conceivable, such as robot spraying methods (or: robotic spray printing process) with masks. The metallic plate 210 can be a metal layer with an electrically insulating coating 215 directly attached to it.

In an optional step S03, an insulating layer 120 is applied to the metallic plate 210 (in particular directly to the insulating coating 215), with the deformation measuring structures 140 being embedded in the insulating layer 120. In this case, the insulating layer encloses the deformation measuring structures 140 at least laterally (i.e. within a layer of electrically conductive tracks 130 in which the deformation measuring structures are formed), and preferably additionally on all sides. Alternatively or additionally, an electrically insulating plastic foam 160 can also be applied in this step.

In a step S04, the metallic plate 210, 215 (optionally with the insulating layer 120 attached to it) is fastened to the inside of a tray bottom 191 of a composite material formed into a tray shape 205, for example by gluing.

In an optional step S01, the composite material can first be formed in the tray shape 205, for example by injection molding or compression molding. The composite material can, for example, be a fiber composite material, in particular comprising glass fiber and/or carbon fiber inserts, which is hardened in the shape of the tray shape 205.

In a step S05, further sub-steps can be carried out to produce the battery tray 200, for example (in this order or in a different one):
electrical connecting/contacting of the evaluation device 30 with the conductive tracks of the layer of electrically conductive tracks 130,
applying the plastic foam 160 to the layer of electrically conductive tracks 130,
connecting the evaluation device 30 to the vehicle electronics of a vehicle,
installing the battery 20 in the battery tray 200 and/or
installing the battery tray 200 in the vehicle.

In further optional steps S06-S08, a calibration process of an evaluation device 30 of the battery tray 100 can also be carried out. This calibration process S06-S08 can be carried out immediately after step S04 or step S05 (including one, more or all sub-steps), in particular after the battery tray 200 has been installed in its intended future location, such as a vehicle.

The calibration process S06-S08 can also be carried out several times, in particular regularly or event-based (whenever a service is carried out, whenever a shock is detected, etc.).

In a step S06, an electrical excitation signal 71 is applied to at least some (preferably all) of the deformation measuring structures 140.

In a step S07, a respective signal response 79 of the deformation measuring structures 140 to the respective applied excitation signal 71 is electrically read out, for example by the evaluation device 30, as already explained in the foregoing.

In a step S08, the evaluation device 30 is calibrated (i.e. in particular, its decision algorithm is adapted) in such a way that the respectively read-out signal response 79 indicates an undeformed normal state of the respective deformation measuring structure 140, and deviations in the signal response 79 indicate a deformation state of the respective deformation measuring structure 140.

In further optional steps, for example, an output signal can be output, indicating the normal state and/or deformation state of one or more deformation measuring structures 140, optionally with additional information such as the degree of deformation.

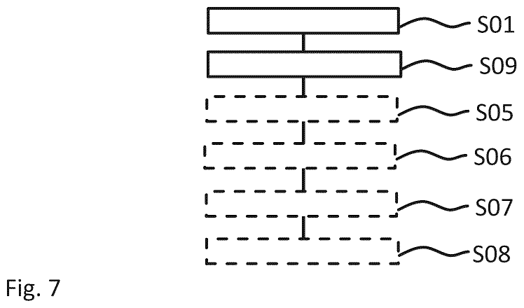

FIG. 7 shows a schematic flow chart explaining a further method for manufacturing a battery tray. The battery tray produced may be the battery tray 100 described in the foregoing, a variant or refinement thereof (as in FIG. 2A or FIG. 2B), or a battery tray different therefrom. Accordingly, the method is adaptable according to all options, variants, embodiments and refinements described in relation to all battery trays according to the invention and in particular the battery tray 100 according to the invention, and vice versa.

In step S01, a composite material is formed in a tray shape 205, for example by injection molding or compression molding. The composite material may, for example, be a fiber composite material, in particular comprising glass fiber and/or carbon fiber reinforcements, which is cured in the shape of the tray shape 205.

In a step S09, a plurality of electrically readable deformation measuring structures 140 are applied to or over the tray shape 205 produced in step S01 by means of a spray printing process. In particular, the deformation measuring structures 140 are applied directly to the tray shape 205. The spray printing process may be carried out by a robot, for example.

Optionally, each of the steps S05-S08 already described above can then subsequently be carried out.

Throughout this specification, unless the context requires otherwise, the word “comprise”, and any variations thereof such as “comprises” or “comprising”, and similarly the words “include”, “includes”, “including”, “contain”, “contains”, “containing”, are to be interpreted in a non-exhaustive sense.

### List of Reference Symbols

20 battery
30 evaluation device
71 excitation signal
79 signal response
100 battery tray
110 first continuous layer
115 coating
120 second continuous layer
130 layer of electrically conductive tracks
140 deformation measuring structures
141 capacitive sensor structure
142 resistive sensor structure
160 plastic foam
190 tray housing
191 tray bottom
192 tray wall
195 concave cavity of the tray shape of the tray housing
200 battery tray
205 tray shape
210 metallic plate
215 coating
290 tray housing
S01 . . . S08 method steps

What is claimed is:

1. A battery tray for accommodating a battery, comprising:
a tray housing;
wherein a layer of electrically conductive tracks is arranged on or above a continuous first layer of the tray housing made of a composite material on the concave side thereof, and
wherein a plurality of electrically readable deformation measuring structures is formed in the layer of electrically conductive tracks at least on a flat section of the tray housing.

2. The battery tray according to claim 1,
wherein the layer of electrically conductive tracks is embedded in a second layer of the tray housing
3. The battery tray according to claim 2,
wherein the second layer is a lacquer coating.

4. The battery tray according to claim 1,
wherein the first layer of the tray housing is formed from a fiber composite material hardened in a corresponding shape.

5. The battery tray according to claim 4,
wherein the fiber composite material comprises glass fiber and/or carbon fiber inserts.

6. The battery tray according to claim 1,
wherein the tray housing comprises a first component formed in a tray shape made of a composite material and a flat metallic second component which is attached to a tray bottom of the tray shape of the first component on the concave side thereof.

7. The battery tray of claim 6,
wherein the flat metallic second component is attached directly to the tray bottom of the tray shape of the first component on the concave side thereof.

8. The battery tray according to claim 6,
wherein the second component is formed as a metallic plate having a thickness of 1 millimeter or less.

9. The battery tray according to claim 8,
wherein the second component is formed as a metallic plate having a thickness of 0.5 millimeter or less.

10. The battery tray according to claim 1,
wherein the deformation measuring structures are at least partially designed as capacitive sensor structures.

11. The battery tray according to claim 10,
wherein the capacitive sensor structures are at least partially designed as interdigital electrodes.

12. The battery tray according to claim 10,
wherein the capacitive sensor structures are covered with a plastic foam on a side facing away from the tray housing.

13. The battery tray according to claim 1,
wherein the deformation measuring structures are at least partially designed as resistive sensor structures.

14. The battery tray according to claim 13,
wherein the resistive sensor structures are covered with a plastic foam on a side facing away from the tray housing.

15. The battery tray according to claim 1,
further comprising an evaluation device which is configured to:
apply an electrical excitation signal to at least a part of the deformation measuring structures,
and read out a respective signal response of the deformation measuring structures to the respective excitation signal in order to determine a normal state or a deformation state of the respective deformation measuring structure based thereupon.

16. The battery tray according to claim 15,
wherein the evaluation device can be calibrated in a calibration process, such that a respective current signal response during the calibration process indicates the normal state and deviations therefrom indicate the deformation state of the respective deformation measuring structure.

17. A method of manufacturing a battery tray, comprising at least the steps of:
manufacturing a tray shape made of a composite material; and
applying a plurality of electrically readable deformation measuring structures to or over the tray shape by means of a spray printing process.

18. The method according to claim 17, further comprising:
applying an electrical excitation signal to at least a part of the deformation measuring structures;
electrical reading out a respective signal response of the deformation measuring structures to the respective applied excitation signal; and
calibrating an evaluation device in such a way that the signal response read out in each case indicates an undeformed normal state of the respective deformation measuring structure and deviations in the signal response indicate a deformation state of the respective deformation measuring structure.

19. A method of manufacturing a battery tray, comprising at least the steps of:
applying a plurality of electrically readable deformation measuring structures to or over a metallic plate; and
fastening the metallic plate to the inside of a tray bottom of a composite material formed in a tray shape.

20. The method according to claim 19, further comprising:
applying an electrical excitation signal to at least a part of the deformation measuring structures;
electrical reading out a respective signal response of the deformation measuring structures to the respective applied excitation signal; and
calibrating an evaluation device in such a way that the signal response read out in each case indicates an undeformed normal state of the respective deformation measuring structure and deviations in the signal response indicate a deformation state of the respective deformation measuring structure.
